(19) United States
(12) Patent Application Publication
(10) Pub. No.: US 2010/0291505 A1
(43) Pub. Date: Nov. 18, 2010

(54) Haptically Enabled Coterminous Production of Prosthetics and Patient Preparations in Medical and Dental Applications

(76) Inventors: Curt Rawley, Windham, NH (US); David Tzu-Wei Chen, Wrentham, MA (US)

Correspondence Address: GOODWIN PROCTER LLP;PATENT ADMINISTRATOR, 53 STATE STREET, EXCHANGE PLACE, BOSTON, MA, 02109-2881, US

(21) Appl. No.: 12/692,459

(22) Filed: Jan. 22, 2010

Related U.S. Application Data
(60) Provisional application No. 61/147,071, filed on Jan. 23, 2009.

(51) Int. Cl. A61C 5/10; A61C 19/04; G06F 17/50

(52) U.S. Cl. 433/72; 433/223; 700/98; 700/119

(57) ABSTRACT

The invention provides a method and system for substantially coterminous modification of a patient situation and a manufactured prosthetic to achieve the desired fit. Rather than utilizing a serial approach, a parallel approach is taken where both patient situation and prosthetic device can be modified at the same time (or substantially the same time).

### CROSS-REFERENCE TO RELATED APPLICATIONS

This application claims priority to and the benefit of U.S. Provisional Patent Application Ser. No. 61/147,071, filed on Jan. 23, 2009, which is hereby incorporated herein by reference in its entirety.

### FIELD OF THE INVENTION

The invention relates generally to systems and methods for manufacturing prostheses. More particularly, in certain embodiments, the invention relates to the use of haptic guides in the coterminous production of prosthetics and patient preparations.

### BACKGROUND OF THE INVENTION

In the creation of prosthetics a positive part is generally fabricated to fit a patient's situation. For example, this can be an external prosthetic device such as an artificial leg fitting over a patient's stump or an artificial ear fitting over a patient's skull. Alternatively this can be an internal prosthetic such as an artificial femur ball fitting into a patient's acetabular socket or a prosthetic dental crown fitting over a tooth's stump prepared by the dentist. In general the creation of the prosthetic device is done separately from the preparation of the patient—both in location and in time. A serial approach is taken to preparing and scanning the patient situation first, followed by the creation of prosthetic device at a later time (usually in a different location), followed by the placement of the prosthetic device on or in the patient.

Problems can arise with the fit between the patient's prepared situation and the separately fabricated prosthetic device. In some instances the prosthetic will fit external to the prepared patient situation (consider a dental crown) and in other instances the prosthetic will fit internal to the patient situation (consider cranial maxillo facial prostheses). In less common situations the prosthetic and patient surface can be both internal and external (consider a hip replacement where both the head of the femur and the acetabulum cavity of the pelvic girdle are involved). Getting the adjoining or interacting surfaces to conform to one another in the desired manner is the objective of prosthetic production and placement.

In traditional methods the patient's situation is prepared and captured (either by physical mold or scanning) and based on this data set the prosthetic is produced. Final fit may require modification to either the patient or the prosthetic and in some cases may require the prosthetic to be discarded in favor of attempting to produce a better fitting prosthetic.

### SUMMARY

The invention provides a system and method for substantially coterminous modification of a patient situation and a manufactured prosthetic to achieve a desired fit. Rather than utilizing the serial approach described above, a parallel approach is taken where both patient situation and prosthetic device can be modified at the same time (or substantially the same time). The original patient situation is captured and a preliminary prosthetic design is created—both in 3D and stored as digital models. The preliminary prosthetic design is then modified to allow for interactive production modifications at the time of patient preparation and final prosthetic insertion. At the time of insertion, a physician or dentist prepares the patient surfaces to receive the eventual prosthetic device. As such surfaces are prepared, updated 3D information becomes available for use in the coterminous modifications to the preliminary prosthetic device to ensure the desired fit. Based on original and updated 3D models, haptic guides are produced to guide the physician in making patient based modification and as the physician actually makes such patient side adjustments, a production process simultaneously (or substantially simultaneously) makes modifications on the prosthetic device side. Both patient modification and prosthetic modifications proceed to converge on the desired fit.

Consider a dentist creating a crown. The patient situation is originally scanned prior to any preparation work being done. Based on the scan data, a desired crown over optimal stump is planned. A series of modifications to the patient and to a ‘blank’ crown (could be oversized PFM) are planned using a CAD system. The blank is left in an oversized state (to be further reduced at time of insertion. Haptic guides are created to guide the dentist in performing patient preparation to receive the prosthetic. The dentist employs these guides to prep the patient, and as he does so, the actual changes are recorded and transmitted to a milling machine which is concurrently making modifications to the blank, conforming it to the actual changes the dentist is making to the patient. Both patient and prosthetic and being coterminously processed to achieve the optimally desired fit—including changes that may not match exactly the originally planned solution. Being able to accommodate last minute adjustments or deviations to ensure optimal fit is important.

In certain embodiments, the system includes a surgical or medical tool or other instrument for modifying a patient situation, for example, a drill, in communication with or as part of a haptic interface device. The haptic interface device is configured to provide force feedback to the user (e.g., doctor, surgeon, dentist, medical practitioner) and receive input from the user. The system may also include a graphical interface configured to provide graphical feedback to the user. In certain embodiments, the system also includes a rapid prototyping (RP) device or milling machine for fabrication and/or modification of a prosthesis (prosthetic device). The system includes a computer with a processor and appropriate software modules, for example, for creating and updating the 3D models of the prosthetic device and the patient situation and for control of the mechanics that provide the force feedback to the user, the mechanics that modify the patient situation, and the mechanics that fabricate or modify the prosthesis.

In certain embodiments, an initial patient consultation involves 3D digital capture of the initial patient situation to create an initial 3D model. From this, a preliminary 3D model of a prosthesis is designed, and the preliminary prosthesis is manufactured. In a follow-up patient visit or in the same visit as the initial consultation, the patient preparation takes place wherein the preliminary prosthesis is substantially simultaneously modified according to any deviation in the patient preparation from that which is used as basis for the preliminary prosthesis. Haptic guided modification of the patient situation further aides in the modification of the patient situation, but in certain embodiments, the haptic guide is not used.

In one aspect, the invention is directed to a method for manufacture of a prosthesis, the method comprising the steps of: (a) creating an initial 3D model of a patient situation; (b) creating a preliminary 3D model of a prosthesis (or a 3D model of a cast/mold of a prosthesis) at least using the initial 3D model of the patient situation; (c) manufacturing a preliminary prosthesis at least using the preliminary 3D model of the prosthesis (or cast/mold of the prosthesis); (d) creating and/or updating a haptic and/or graphic guide at least using one or more of the following: (i) the initial 3D model of the patient situation; (ii) an updated 3D model of the patient situation; (iii) the preliminary 3D model of the prosthesis (or cast/mold of the prosthesis); and (iv) an updated 3D model of the prosthesis (or cast/mold of the prosthesis); (e) modifying the patient situation at least using an instrument comprising a haptic and/or graphic interface device implementing the haptic/graphic guide and updating the 3D model of the patient situation (e.g., according to the actual modification of the patient situation); and (f) modifying the prosthesis and/or mold (or cast) of the prosthesis with a machine (e.g., a milling machine, a rapid prototyping device, etc.) substantially coterminously with step (e) (e.g., according to the updated 3D model of the patient situation) and, optionally, updating the 3D model of the prosthesis (or cast/mold of the prosthesis). For example, the actual modification of a preliminary prosthesis will reflect deviation in the patient preparation from the 3D model of the prescribed patient preparation, which served as the basis for the preliminary prosthesis.

In certain embodiments, steps (e) and (f) are repeated until a prosthesis with proper fit is converged upon. In certain embodiments, the prosthesis comprises an artificial limb (e.g., an artificial hand, arm, leg, or foot), an internal prosthetic (e.g., a femur ball fitting into a patient's acetabular socket); (iii) a dental prosthetic (e.g., a dental crown fitting over a tooth stump prepared by a dentist); and/or (iv) a cranial/maxillo facial prosthetic.

In certain embodiments in which a haptic guide is used, the haptic guide serves to restrict or otherwise guide the movement of the instrument during the modification of the patient situation by providing force feedback to the user (e.g., where the force feedback allows the user to distinguish between planned or safe excision from unplanned or unsafe excision—e.g., the force feedback may prevent or makes difficult excision from regions outside the determined, planned or safe region for excision). Where a graphic guide is used, the graphic guide can serve to provide a visual signal to the user via a visual display, e.g., allowing the user to distinguish between planned or safe excision from unplanned or unsafe excision. Additionally or alternatively to the haptic and/or graphic guides, the system may use an audible guide (which is created and/or updated in the same way as the haptic and/or graphic guides, or is simply tied to the output of the haptic and/or graphic guides), which provides the user an audible signal, e.g., allowing the user to distinguish between planned or safe excision from unplanned or unsafe excision. Any combination of haptic, graphic, and/or audible guides may be used.

In another aspect, the invention is directed to a system for manufacture of a prosthesis, the system comprising: an instrument for modifying a patient situation (e.g., a drill), in communication with or operating as part of a haptic interface device, wherein the haptic interface device is configured to provide force feedback to a user (e.g., doctor, surgeon, dentist, medical practitioner) and receive input from the user; a display configured to provide graphical feedback to the user; a rapid prototyping (RP) device or milling machine for fabrication and/or modification of a prosthesis and/or cast/mold of a prosthesis; a computer with a processor and instructions configured to: (a) create an initial 3D model of a patient situation; (b) create a preliminary 3D model of the prosthesis (and/or mold/cast of the prosthesis) at least using the initial 3D model of the patient situation; (c) provide data for use by the rapid prototyping (RP) device or milling machine to fabricate a preliminary prosthesis (and/or cast/mold of the prosthesis) at least using the preliminary 3D model of the prosthesis (and/or cast/mold of the prosthesis); and (d) create and/or update the haptic guide at least using one or more of the following: (i) the initial 3D model of the patient situation; (ii) an updated 3D model of the patient situation; (iii) the preliminary 3D model of the prosthesis (and/or cast/mold of the prosthesis); and (iv) an updated 3D model of the prosthesis (and/or cast/mold of the prosthesis).

In certain embodiments, the system is used in performing the method comprising the steps of: (a) creating an initial 3D model of a patient situation; (b) creating a preliminary 3D model of a prosthesis (or a 3D model of a cast/mold of a prosthesis) at least using the initial 3D model of the patient situation; (c) manufacturing a preliminary prosthesis at least using the preliminary 3D model of the prosthesis (or cast/mold of the prosthesis); (d) creating and/or updating a haptic and/or graphic guide at least using one or more of the following: (i) the initial 3D model of the patient situation; (ii) an updated 3D model of the patient situation; (iii) the preliminary 3D model of the prosthesis (or cast/mold of the prosthesis); and (iv) an updated 3D model of the prosthesis (or cast/mold of the prosthesis). (e) modifying the patient situation at least using an instrument comprising a haptic and/or graphic interface device implementing the haptic/graphic guide and updating the 3D model of the patient situation according to the actual modification of the patient situation; and (f) modifying the prosthesis and/or mold (or cast) of the prosthesis with a machine (e.g., a milling machine, a rapid prototyping device, etc.) substantially coterminously with step (e) (e.g., according to the updated 3D model of the patient situation) and updating the 3D model of the prosthesis (or cast/mold of the prosthesis), where, in certain embodiments, steps (e) and (f) are repeated until a prosthesis with proper fit is converged upon.

In another aspect, the invention is directed to a method for manufacture of a dental crown, the method comprising the steps of: (a) scanning a patient situation to create an initial 3D model thereof; (b) creating an initial 3D model of a crown using said initial 3D model of the patient situation and manufacturing a preliminary crown using the initial 3D model of the crown; (c) modifying the patient situation for fitting of the crown and updating the 3D model of the patient situation in accordance thereto; and (d) modifying, substantially coterminously with step (c), the preliminary crown with a machine using at least the updated 3D model of the patient situation. In certain embodiments, steps (c) and (d) are repeated until a crown with proper fit is converged upon.

In certain embodiments, the method includes creating and/or updating a haptic guide using one or more of the following: (i) the initial 3D model of the patient situation; (ii) the updated 3D model of the patient situation; (iii) the preliminary 3D model of the crown; and (iv) the updated 3D model of the crown, wherein step (c) comprises modifying the patient situation using the created and/or updated haptic guide. In certain embodiments, the haptic guide serves to restrict or otherwise guide the movement of the instrument during the modification of the patient situation. In certain embodiments, the method further includes manually modifying the crown for fine adjustment.

### BRIEF DESCRIPTION OF THE DRAWINGS

The objects and features of the invention can be better understood with reference to the drawings described below, and the claims. The drawings are not necessarily to scale, emphasis instead generally being placed upon illustrating the principles of the invention. In the drawings, like numerals are used to indicate like parts throughout the various views.

FIG. 1 is a block diagram showing elements of a system for the haptic, digital design and fabrication of a prosthesis, in accordance with an illustrative embodiment of the invention.

FIG. 2 is a schematic representation of a hand-held oral scanner capable of creating a three-dimensional representation of an object, in accordance with an illustrative embodiment of the invention.

FIG. 3 is a schematic representation of a PHANTOM® force-feedback haptic interface device fitted with an instrument for modifying a patient situation, in accordance with an illustrative embodiment of the invention.

FIG. 4 is a flow chart showing steps in a typical “serial” workflow procedure for the design and fabrication of a crown.

FIG. 5 is a flow chart showing steps in a procedure for the haptic, digital design and fabrication of a crown employing coterminous modification of the patient situation and the manufactured crown, in accordance with an illustrative embodiment of the invention.

FIG. 6 is a flow chart showing steps in a procedure for the haptic, digital design and fabrication of a crown employing coterminous modification of the patient situation and the manufactured crown, where design software is used to create both a “full anatomy” shape for the final crown, as well as a surgical plan for the shape of the stump on the broken tooth, according to an illustrative embodiment of the invention.

### DETAILED DESCRIPTION

Throughout the description, where processes, systems, and methods are described as having, including, or comprising specific steps and/or components, it is contemplated that, additionally, there are processes, systems, and methods according to the present invention that consist essentially of, or consist of, the recited steps and/or components.

It should be understood that the order of steps or order for performing certain actions is immaterial so long as the invention remains operable. Moreover, two or more steps or actions may be conducted simultaneously.

Embodiments of the invention may be used with methods and systems described in the following patents and/or applications, the texts of which are hereby incorporated by reference in their entirety: pending U.S. patent application Ser. No. 12/321,766, titled, “Haptically Enabled Dental Modeling System,” by Steingart et al., published as U.S. Patent Application Publication No. 2009/0248184; pending U.S. patent application Ser. No. 11/998,457, titled, “Systems for Haptic Design of Dental Restorations,” by Steingart et al., published as U.S. Patent Application Publication No. 2008/0261165; pending U.S. patent application Ser. No. 11/998,877, titled, “Systems for Hybrid Geometric/Volumetric Representation of 3D Objects,” by Faken et al., published as U.S. Patent Application Publication No. 2008/0246761; U.S. Pat. No. 7,149,596, titled, “Apparatus and Methods for Modifying a Model of an Object to Enforce Compliance with a Manufacturing Constraint,” by Berger et al.; U.S. Pat. No. 6,958,752, titled, “Systems and Methods for Three-Dimensional Modeling,” by Jennings, Jr. et al.; U.S. Pat. No. 6,867,770, titled, “Systems and Methods for Voxel Warping,” by Payne; U.S. Pat. No. 6,421,048, titled, “Systems and Methods for Interacting With Virtual Objects in A Haptic Virtual Reality Environment,” by Shih et al.; and U.S. Pat. No. 6,111,577, titled, “Method and Apparatus for Determining Forces to be Applied to a User Through a Haptic Interface,” by Zilles et al.

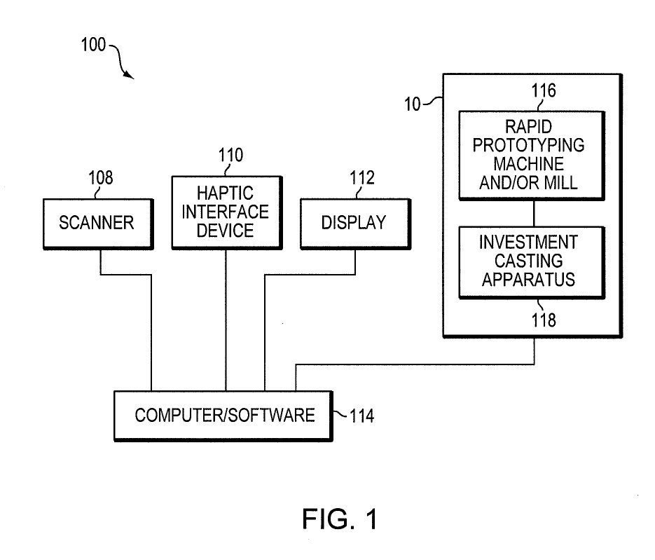

FIG. 1 is a block diagram 100 showing elements of a system for the manufacture of a prosthesis. These elements are introduced here and are described in more detail elsewhere herein. In the block diagram of FIG. 1, dotted lines indicate the element or feature is optional, but may be advantageously included for particular applications. The system of FIG. 1 includes a scanner 108, an instrument incorporating a haptic interface device 110, a display 112, and a prosthesis preparation unit 106 in communication with a computer 114 upon which system software runs. In certain embodiments, the elements in block 102 are associated with the acquisition of data regarding the patient situation and design of the prosthesis adapted to the scanned patient situation. The scanner 108, haptic interface device/instrument 110, display 112, and computer 114 may be located, for example, at a dentist's, doctor's, or other medical practitioner's office, and output data may be fed through a client/server network and/or the internet to a subsystem 106 for coterminous fabrication of the designed prosthesis outside the medical practitioner's office. Alternatively, all elements, including the prosthesis preparation unit 106 may be co-located at a dentist's or doctor's office. The elements of subsystem 106 may be on site at the dentist's office, or may be offsite at a dental lab, for example. In certain embodiments, the fabrication elements 10 include a rapid prototyping machine and/or mill 116, and may optionally include an investment casting apparatus 118 (e.g., for fabrication of partials or other complex dental restorations).

In certain embodiments, the haptic interface device/instrument 110 delivers force feedback to the user during modification of the patient situation, according to a haptic guide that is computed by the computer/software 114 using initial and/or updated 3D models of the patient situation and/or the prosthesis. The haptic guide is used to provide force feedback via the haptic interface device/instrument 110 to permit or facilitate removal of material (or other modification of the patient situation) within the required or recommended regions, and to disallow or make difficult removal of material within other regions.

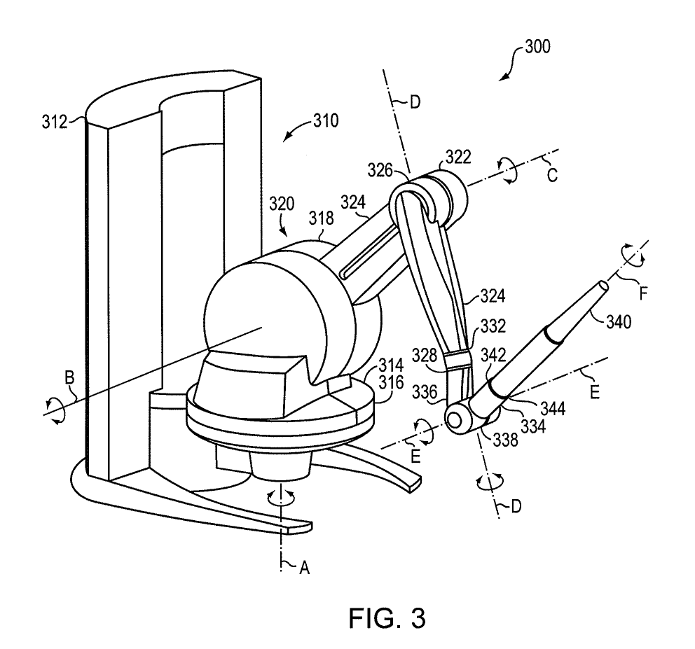

A graphic guide can be provided along with or in place of the haptic guide. The graphic guide may provide a graphical map or other indication showing where modification of the patient situation is prescribed (e.g., tissue or bone removal) and where it is not, according to an updated graphic guide (may be same basis as haptic guide). An audible guide may be optionally provided, e.g., an alarm warning indicating that modification of the patient situation is taking place (or is about to take place) outside the prescribed region, and/or a pleasant/agreeable sound indicating that modification of the patient situation is taking place within the prescribed region. Any combination of haptic, graphic, and/or audible guides may be used. In certain embodiments in which only a graphic guide is used, the haptic interface device/instrument 110 in FIG. 1 is replaced with a graphic interface device similar to the haptic device described herein (e.g., the device shown in FIG. 3, capable of tracking the movement of the instrument about/within the patient situation), but which does not deliver haptic feedback to the user.

In certain embodiments, the scanner 108 in the system of FIG. 1 uses multiple light sources and multiple image sensors to eliminate the need to make multiple exposures and combine them algorithmically into a single composite description. Further, the elimination of multiple exposures eliminates the need to move the scanning apparatus and/or the prosthesis or patient situation being scanned. The elimination of these constraints improves the accuracy, reliability and speed of operation of the scanning process as well as the ability to scan negative impressions. Furthermore, the scanner has no moving parts, thereby improving accuracy and reliability of operation. The scanner makes use of multiple triangulation angles, improving accuracy, and multiple frequencies among light sources, with multiple sensors specific/sensitive to those light frequencies, improving reliability of results. The scanner also provides greater spatial coverage of dental structures using single exposures, improving accuracy and reliability.

In certain dental applications of the system of FIG. 1, the scanner 108 works by positioning the scanning apparatus directly in the mouth of the patient (in the case of an intra-oral scanner) or inside a light-tight desk-top box together with an impression of the dental structure of interest (e.g. molded impression). The relative positions and orientations of the light sources and imaging sensors are known and are fixed. The 3D coordinates of points illuminated by the light sources can then be computed by triangulation. The accuracy of these computations depends on the resolution of the imaging sensor. Given finite resolution, there will be round-off error. The purpose of using multiple light sources and imaging sensors is to minimize the effects of round-off error by providing multiple 3D coordinates for illuminated points. The purpose of keeping the spatial relationships between light sources and imaging sensors fixed) by eliminating moving parts) is to minimize the error in interpolating the multiple 3D coordinates.

Using multiple light sources and imaging sensors also minimizes the amount of movement of the apparatus and/or the dental structure being scanned when scanning larger structures. This in turn minimizes blending or stitching 3D structures together, a process that introduces round-off errors. Using multiple light sources and imaging sensors also allows cavity depths to be more easily measured, because more 3D points are “visible” to (can be detected by) one or more sources and sensors.

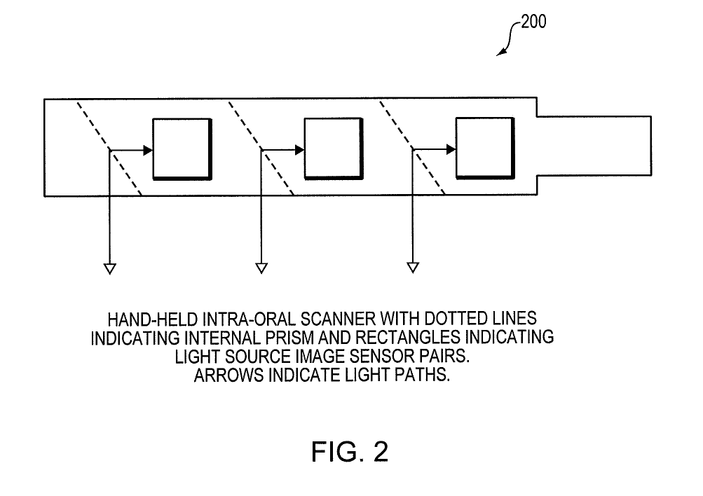

FIG. 2 is a diagram 200 of an illustrative hand-held scanner 108 (e.g., intra-oral scanner) with multiple CCDs. The dashed lines 202 indicate internal prisms, the rectangles 204 indicate light source/image sensor pairs, and the arrows indicate light paths. When scanning a patient situation using the scanner 108, or alternatively, when scanning an impression of the patient situation (e.g., dental impression), the system features the use of haptics to allow an operator to physically sense a contact point (or points) corresponding to the scanned impression, or the patient's situation (e.g. mouth tissue), through a force feedback interface, for use in registration of scan inputs. The haptic device encodes data identifying the location of the device in 3D Cartesian coordinate space. Thus, the location of the device (corresponding to the contact point(s) of the scanned object) is known, and as an operator senses that contact point, he/she can click a stylus button to let the system know to capture that location which can later serve as one or more registration points for scans made relative to that/those contact point(s).

In one embodiment, the scanner creates a virtual representation of an impression of the patient's situation (e.g., mouth tissue, teeth, gums, fillings, appliances, etc.). The impression may be a hardened gel impression obtained via known methods. The scan of the impression is a scan of a negative. The scanner described herein allows for avoidance of specularities and occluded surfaces by scanning an impression of the patient's teeth and gums. Use of speckled or patterned matter in the impression material may serve as potential reference markers in tracking and scanning. Color frequency encoding may be used to identify potential reference points in scanning and tracking. As described above, it is possible to identify multiple marker points within the impression to aid convergence of the scanning algorithms in constructing a 3D model of the patient's situation. Impressions reveal specularities with which to deal. Since an impression is a free standing object, it can be easily moved around for better scanning. The use of impressions of multiple colors can provide surface information to aid in determining surface points.

In another embodiment, the scanner creates a virtual representation of a directly-scanned patient situation (e.g., mouth tissue, teeth, gums, fillings, appliances, etc.). The scan of the patient situation is a scan of a positive. Here, DPL technology is used to illuminate grid patterns, optionally employing multiple colors to aid in the construction of 3D models. Color photographs of the patient situation may be used to assist in the construction of the 3D models and later mapping of these images onto the 3D models using a u-v mapping technology.

One, two, three, or more of the following may be used for registration of the scanning results for determination of an optimal 3D model of the patient's situation: structured light scans, cone beam data, photographs, x-rays, CT, MRI, voxel data, and STL data. In certain embodiments, low cost CCD sensors and light (single or multiple frequency) sources are simultaneously used to provide automatic registration and to eliminate any moving parts. In certain embodiments, a combination of parallax and triangulation methods are used to converge an optimal 3D model of the patient situation.

The following is a description of triangulation. If we take a plane of light with the equation Ax+By+Cz+D=0 and project it onto an object in 3D space, the projection of that plane onto the object surface will be a line whose shape is distorted by the object surface. If we have an image plane whose location and orientation are known with respect to the plane of light), we can choose a point (x′,y′) along the line as it appears in the image plane and compute its coordinates in 3D space as follows:

z=−D*f/(Ax′+By′+Cf) (1)

x=x′*z/f (2)

y=y′*z/f (3)

where f is the focal length associated with the imaging sensor.

For example, assume the viewer is located on the Z-axis at z=1 and the image plane is located in the X-Y plane at the origin (in 3D space) and the viewer is looking down the −Z axis. If we place the plane of light at say, z=−10, then A=B=0, C=1 and D=10. If we have the plane intersecting a sphere of radius 10 centered at z=−10 and let f=1, then the formulas above will give a depth of −10 for any point on the circle in the image plane representing the intersection of the plane of light with the sphere. The (x,y) coordinates of the points on the sphere corresponding to points on the circle of radius 1 centered in the image plane will lie on a circle of radius −10 in the plane z=−10.

FIG. 3 is a schematic perspective view 300 of an exemplary six degree of freedom force reflecting haptic interface device 310 that can be used in accordance with the haptic instrument 110 for modifying a patient situation (e.g., drill, scalpel, laser, etc.) in the system of FIG. 1. The interface 310 (110) can be used by a user to provide input to a device, such as a computer (114), and can be used to provide force feedback from the computer to the user. The six degrees of freedom of interface 310 are independent.

The interface 310 includes a housing 312 defining a reference ground, six joints or articulations, and six structural elements. A first powered tracked rotary element 314 is supported by the housing 312 to define a first articulation 316 with an axis “A” having a substantially vertical orientation. A second powered tracked rotary element 318 is mounted thereon to define a second articulation 320 with an axis “B” having a substantially perpendicular orientation relative to the first axis, A. A third powered tracked rotary element 322 is mounted on a generally outwardly radially disposed extension 324 of the second element 318 to define a third articulation 326 having an axis “C” which is substantially parallel to the second axis, B. A fourth free rotary element 328 is mounted on a generally outwardly radially disposed extension 330 of the third element 322 to define a fourth articulation 332 having an axis “D” which is substantially perpendicular to the third axis, C. A fifth free rotary element 334 is mounted on a generally outwardly radially disposed extension 336 of the fourth element 328 to define a fifth articulation 338 having an axis “E” which is substantially perpendicular to the fourth axis, D. Lastly, a sixth free rotary user connection element 340 in the form of a stylus configured to be grasped by a user is mounted on a generally outwardly radially disposed extension 342 of the fifth element 334 to define a sixth articulation 344 having an axis “F” which is substantially perpendicular to the fifth axis, E.

The stylus 340 may be connected to or form part of an instrument for modifying the patient situation (e.g., a dental drill, a scalpel, a laser, etc.). The extensions (e.g., 324, 330, and/or 336) may be resized and/or repositioned for adaptation to various systems. The haptic interface of FIG. 3 is fully described in U.S. Pat. No. 6,417,638, issued on Jul. 9, 2002, which is incorporated by reference herein in its entirety. Those familiar with the haptic arts will recognize that there are different haptic interfaces that convert the motion of an object under the control of a user to electrical signals, different haptic interfaces that convert force signals generated in a computer to mechanical forces that can be experienced by a user, and different haptic interfaces that accomplish both results, which may be adapted for use in the systems and methods described herein.

The computer 114 in FIG. 1 can be a general purpose computer, such as a commercially available personal computer that includes a CPU, one or more memories, one or more storage media, one or more output devices, such as a display 112, and one or more input devices, such as a keyboard. The computer operates using any commercially available operating system, such as any version of the Windows™ operating systems from Microsoft Corporation of Redmond, Wash., or the Linux™ operating system from Red Hat Software of Research Triangle Park, N.C. In some embodiments, a haptic device such as the interface 310 is present and is connected for communication with the computer 114, for example with wires. In other embodiments, the interconnection can be a wireless or an infrared interconnection. The interface 310 is available for use as an input device and/or an output device. The computer is programmed with software including commands that, when operating, direct the computer in the performance of the methods of the invention. Those of skill in the programming arts will recognize that some or all of the commands can be provided in the form of software, in the form of programmable hardware such as flash memory, ROM, or programmable gate arrays (PGAs), in the form of hard-wired circuitry, or in some combination of two or more of software, programmed hardware, or hard-wired circuitry. Commands that control the operation of a computer are often grouped into units that perform a particular action, such as receiving information, processing information or data, and providing information to a user. Such a unit can comprise any number of instructions, from a single command, such as a single machine language instruction, to a plurality of commands, such as a plurality of lines of code written in a higher level programming language such as C++. Such units of commands are referred to generally as modules, whether the commands include software, programmed hardware, hard-wired circuitry, or a combination thereof. The computer and/or the software includes modules that accept input from input devices, that provide output signals to output devices, and that maintain the orderly operation of the computer. In particular, the computer includes at least one data input module that accepts information from the interface 310 which is indicative of the state of the interface 310 and its motions. The computer also includes at least one module that renders images and text on the display 112. In alternative embodiments, the computer 114 is a laptop computer, a minicomputer, a mainframe computer, an embedded computer, or a handheld computer. The memory is any conventional memory such as, but not limited to, semiconductor memory, optical memory, or magnetic memory. The storage medium is any conventional machine-readable storage medium such as, but not limited to, floppy disk, hard disk, CD-ROM, and/or magnetic tape. The display 112 is any conventional display such as, but not limited to, a video monitor, a printer, a speaker, an alphanumeric display, and/or a force-feedback haptic interface device. The input device is any conventional input device such as, but not limited to, a keyboard, a mouse, a force-feedback haptic interface device, a touch screen, a microphone, and/or a remote control. The computer 114 can be a stand-alone computer or interconnected with at least one other computer by way of a network. This may be an internet connection.

In certain embodiments, the software 114 in the system of FIG. 1 includes software for haptic, digital modeling. 3D models of the patient situation and the prosthesis (or mold/cast of the prosthesis) are created and updated in real time according to the actual modification of the patient situation and/or prosthesis (or prosthetic cast/mold) during the fitting procedure. The software 114 operates to create or update a haptic guide that provides force feedback to the user during modification of the patient situation, using the updated 3D models of the patient situation and prosthesis. This allows coterminous (or substantially coterminous) modification of the prosthesis with the modification of the prosthesis (or cast/mold of the prosthesis). For example, a preliminary prosthesis may be designed, based on initial 3D models of the patient situation and prosthesis. The actual modification of a prosthesis such as a dental crown may be made in real-time as the patient situation is being modified (the tooth stump is being shaped for receiving the crown), and such modification can take into account any deviation in the patient preparation from that which served as the basis for a preliminary prosthesis.

Voxel representation may be employed in the 3D models of the patient situation and/or prosthesis (or prosthetic cast/mold). Voxels are advantageous for sculpting and carving virtual objects with organic shapes, such as teeth, bridges, implants, and the like. Other data representations may be used, for example, point clouds, polymeshes, NURBS surfaces, and others, in addition to, or instead of, voxel representation. A combination of voxel representation with one or more other types of data representation may also be used, for example, such that the benefit of voxel representation in sculpting and carving can be achieved, while the benefit of another data representation (e.g., NURBS curve for representing the preparation line) may be additionally achieved.

The system is a touch-enabled modeling system that allows the operator to create and/or interact with complex, organic shapes faster and easier than with traditional CAD systems. The fact that the modeling system is haptic (e.g., provides meaningful force-feedback to an operator) allows for intuitive operation suitable for creating and interacting with models of organic shapes, for example, as needed in the methods and systems described herein for coterminous manufacture of a prosthesis and modification of a patient situation for fitting of the prosthesis.

For embodiments for the manufacture of dental prostheses, the models provide for the automated or semi-automated identification of the patient's margin (prep) line using a combination of mathematic analysis of polygonal surface properties—for example, determining where sharp changes of tangency occur—and the operator's haptically enabled sense of touch to refine mathematical results into a final 3D closed curve. The models also feature automatic offset shelling from interior concavity (negative of the stump) surface of the prosthetic utilizing voxel data structures. This provides a modified surface which can be used to accommodate dental cement or bonding agents between the patient's actual stump and the interior surface of the prosthetic device. The models also feature automatic offset shelling from the exterior surface of the prosthetic utilizing voxel data structures. This provides a modified surface which can be used to compensate for shrinkage of the actual prosthetic device during processing or to accommodate additional surface treatments. The shelling can be used to either increase or decrease the volume contained by the exterior surfaces. The model also feature a method of detecting collisions between objects in order to sense the fit of the virtual or actual prosthetic device and to make adjustments for occlusions with adjacent and opposing teeth.

In certain embodiments, the system uses scanning and/or motion tracking to capture general and specific articulation of patient movement—e.g., grinding, chewing, clenching—for later use in testing the fit of restorative work. In effect, this can be described as inverse kinematics in computer animation. The haptic functionalization of the model allows further interactivity, allowing the user to “feel” the fit of restorative work during patient movement.

In certain embodiments, the model provides a method for quality control of the physical prosthetic employing a scan of final manufactured prosthetic with haptically enabled sensing of surface areas. The method features color coding of surface areas of particular interest to the dentist along with the ability to haptically mark areas on a 3D model of the scan data for reference by the dentist in final modifications to the prosthetic.

In certain embodiments, methods of the invention include creating and employing a standard library of prosthetic models (e.g., tooth models) in voxel data form whereby the standard model can be imported upon request and instantly made available for automatic or manual alteration. The library can take varying degrees of customization—e.g., from creating patient specific models of all teeth prior to any need to restorative work to utilizing standard shapes for each tooth based on patient specific parameters.

Haptics allows intuitive, interactive checking of alignment of implants and implant bars, for example. Multiple complex draft angle techniques may be used to verify insertion and removal will be possible without undue stress. For example, if four implants are used in a restoration, the first and fourth cannot be angled away from each other because the implant bar will not be able to slide on and off easily. The models can automatically detect draft angle and show conflicts in color.

In addition to haptic guides for providing force feedback during modification of the patient situation, haptics may also be used in creating and modifying surgical guides, for example, in the alignment of crowns, implants, and/or bars. Haptics can be used to help set drilling angles and/or to produce guide fixtures for use in surgical procedures. Haptic methods can also aid in the detection of potential prep line or tooth shape problems at the initial virtual modeling stage (e.g., preparation of initial prosthesis from initial 3D model of the patient situation) or the manufacture stage. Haptic functionality of the modeling system allows the operator to feel what can't necessarily be seen—feeling a feature virtually before committing to a modification can help the operator conduct the operation more smoothly, as in pre-operative planning. The operator can detect occlusions, explore constraints in maneuvering the prosthetic into place, and can detect areas that might catch food or present problems in flossing, all by “feeling” around the model haptically, before the restoration is actually made.

In restorative work involving implants, it important not to over stress the gum tissue as it can be damaged or killed. Implants typically involve a metal post or sprue that is mounted into the jaw bone; a metal abutment that is attached to the top of the post; and a prosthetic tooth that is joined to the abutment. The area where post, abutment, and restorative prosthetic come together involves working at or just below the gingival line (gum line). Modeling different materials and associating with them certain properties (e.g. elasticity) offers an ability for the dentist or orthodontist to plan and practice the operation in a virtual workspace—testing the limits of the patient tissues prior to actual operation. The use of multiple densities and collision detection may be involved as well.

In the system of FIG. 1, the prosthesis (and/or cast/mold of the prosthesis) is fabricated with a rapid prototyping machine and/or a milling machine (mill) 116, for example, a 3-D printer or an integrated, desk-top mill. The system may include software that converts the file format of the modeled restoration into a format used by the rapid prototyping machine and/or desk-top mill, if necessary. For example, STL file output from the model may be converted to a CNC file for use as input by a desk-top mill.

Methods to enhance the production stage (e.g., milling or rapid prototyping) are provided. For example, the model provides the ability to compensate for material shrinkage by utilization of its shelling techniques, described herein. Also, the system can provide colored voxels in the 3D models for use as input by the additive manufacturing processes (e.g., rapid prototyping) capable of producing varying colors and translucency in the materials used to create the prosthetics.

The milling machine is sized for dental applications. Exemplary milling machines are those used in the CEREC system (Sirona), or any desk-top mill adapted for dental applications, for example, CNC milling machines manufactured by Delft Spline Systems, Taig Tools, Able Engraving Machines, Minitech Machinery Corporation, Roland, and Knuth.

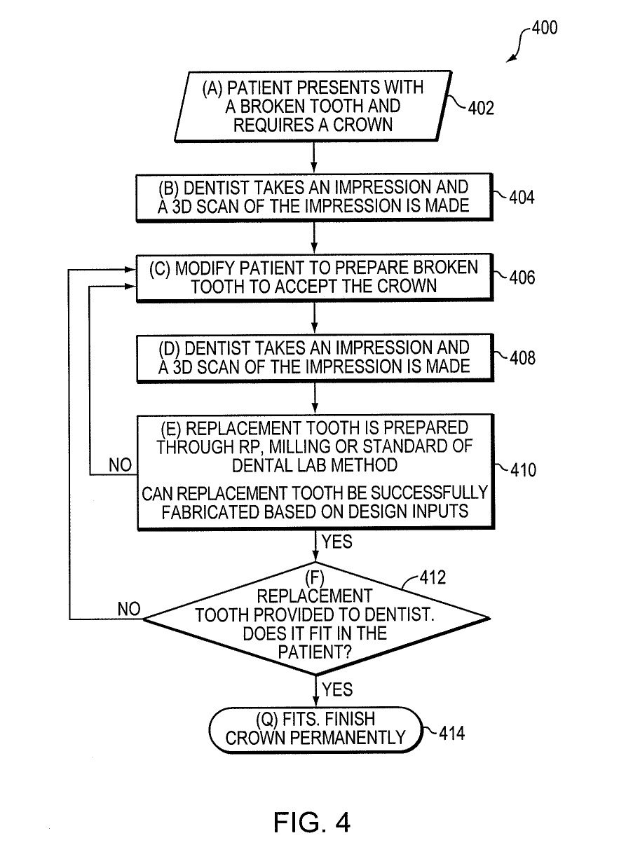

Consider the workflow steps for the dentist and patient in the typical process of creating a crown (or other prosthetic) for a broken tooth. FIG. 4 is a flow chart 400 showing steps in a typical “serial” workflow procedure for the design and fabrication of a crown. In the typical “serial” workflow, each of these steps is done in sequence and necessitates patient waiting and follow-up visits. In step A (402), a patient presents with a broken tooth and requires a crown. At step B (404), the dentist takes an impression and a 3D scan of the impression is made. In step C (406), the patient situation is modified to prepare the broken tooth to accept the crown. In step D (408), the dentist takes an impression and a 3D scan of the impression is made. In step E (410), the replacement tooth is prepared through rapid prototyping, milling, or standard dental lab methods. It is then determined whether or not a replacement tooth can be successfully fabricated based on design inputs.

A “NO” at step E (410) implies that the patient modification (tooth preparation) done at step C (406) was inconsistent with the design constraints for the crown and that this inconsistency is caught at the Dental Lab before the tooth is actually made. The scope of these design constraints can include, for example:
Too much undercut at the margin line for the crown;
The margin line is too jagged or otherwise undefined;
The bite articulation was not correctly analyzed so there is not enough tooth material removed on the top surface, leaving insufficient room to design the top surface of the crown;
Not enough tooth material was removed next to an adjacent tooth, leaving insufficient room to create the contacting surface of the crown; and/or
Poor impression was made at the Dentist's office.

If the replacement tooth is inconsistent with design constraints, the process returns to step C (406) of the flowchart to repeat patient modification and subsequent impression in step 408. When the replacement tooth is consistent with design constraints, the replacement tooth is manufactured and provided to the dentist (step F). A determination is made in step F (412) whether the replacement tooth fits in the patient.

A “NO” at step (F) indicates that the design inconsistencies as described above were not recognized in advance and so a poorly fitting replacement is created and provided to the Dentist. Thus, a “NO” at either step C or step F will require another patient visit to possibly modify the “stump” or the new crown to achieve a proper fit. Only after proper fit is achieved is the crown finished permanently at step G (414).

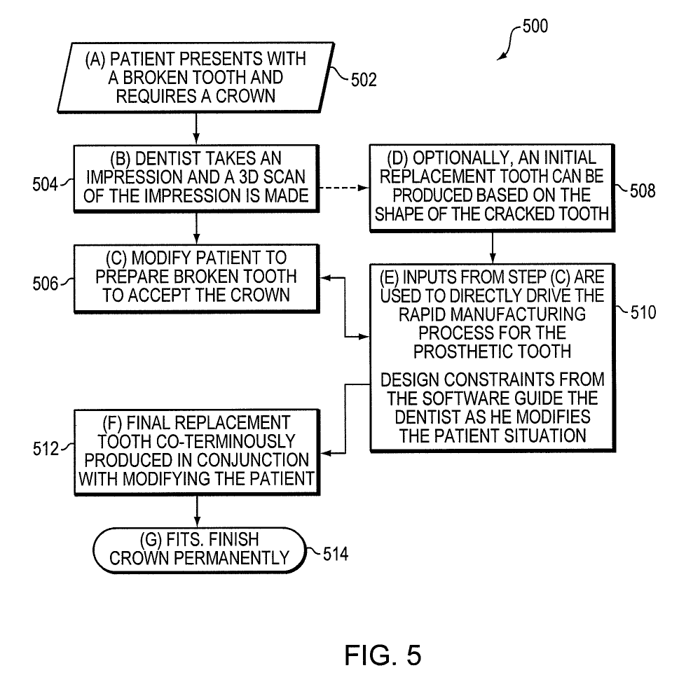

FIG. 5 is a flow chart showing steps in a procedure for the haptic, digital design and fabrication of a crown employing coterminous modification of the patient situation and the manufactured crown, in accordance with an illustrative embodiment of the invention.

The purpose of preferred embodiments of the current invention is to achieve a proper fitting prosthetic without follow-on visits by using inputs captured during the patient modification, step C (506), to directly drive a Rapid Manufacturing process for the crown. Note that this new “coterminous” workflow eliminates the decision box at step F (412) in the method of FIG. 4. The lines that loop back to step C (406) in the method of FIG. 4 (indicating repeating step 406 and intervening steps) can be eliminated as well. Thus, the new workflow proposed in this embodiment is able to produce a final, fit prosthetic tooth in a single patient visit.

In the method of FIG. 5, a patient presents with a broken tooth and requires a crown at step A (502). In step B (504), the dentist takes an impression and a 3D scan of the impression is made. Optionally, an initial replacement tooth can be produced based on the shape of the cracked tooth (step D, 508). Following step B, the dentist modifies the patient situation at step C (506), preparing the broken tooth to accept the crown that will be manufactured. In step E (510), inputs from step C (506) are used to directly drive a rapid manufacturing (prototyping) process for the prosthetic tooth/crown. Design constraints from the software guide the dentist as he/she modifies the patient situation. In step F (512), the final replacement tooth is coterminously produced in conjunction with modification of the patient situation in step C (506). In step G (514), the produced crown fits and is permanently finished.

The double arrow between step C (506) and step E (510) in FIG. 5 indicates that as the patient is modified, inputs are gathered—e.g., from a Polhemus 3D tracking device, a coordinate-measuring machine (CMM), the end-effector of a haptic device, or a laser range finder—to directly drive a Rapid Manufacturing device to produce the patient prosthetic. Further, design constraints are simultaneously communicated back to the Dentist in real-time to guide the surgery needed to obtain the optimal patient modification. This communication from step E (510) back to step C (506) can be embodied through graphical, auditory, and/or haptic User Interfaces. In this way, the final replacement tooth produced at step F (512) represents a convergence of the patient's initial tooth morphology, with design constraints and the actual execution of the patient modifications needed to perform a given procedure.

In the case where the Rapid Manufacturing process is purely subtractive, such as with milling, it makes sense to produce a slightly oversized initial replacement tooth after step B (504) in FIG. 5. This may be the initial replacement tooth of step D (508).

Then, during the patient modification step C (506), this oversized “blank” will then be further carved to take on the exact shape to match the Dentist preparation.

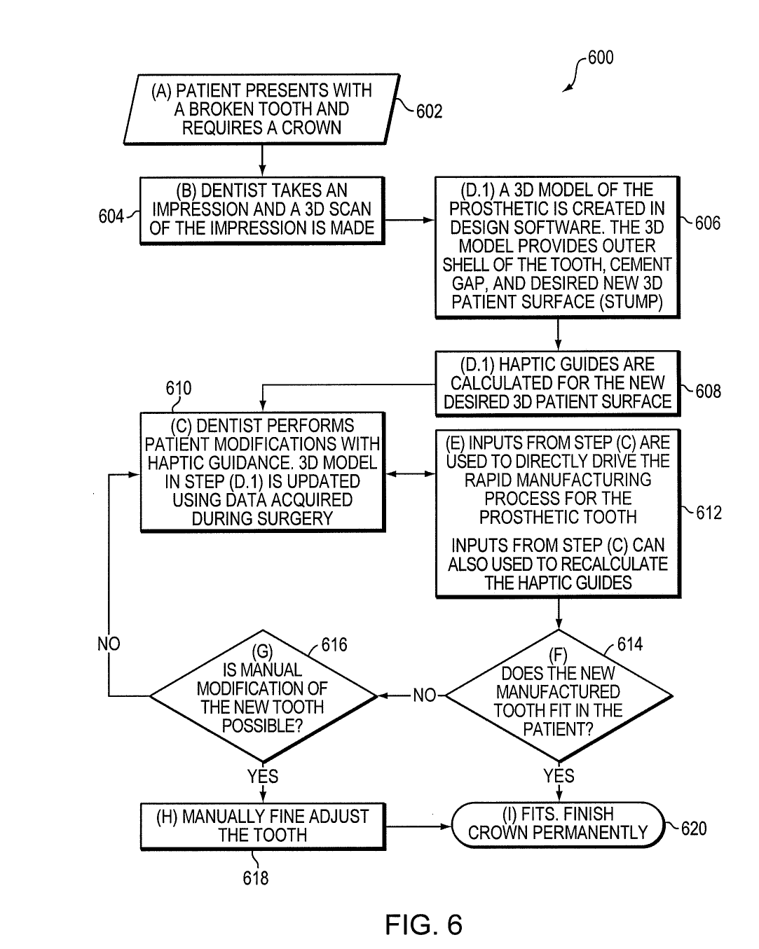

FIG. 6 is a flow chart showing steps in a procedure for the haptic, digital design and fabrication of a crown employing coterminous modification of the patient situation and the manufactured crown, where the design software 114 is used to create both a “full anatomy” shape for the final crown, as well as a surgical plan for the shape of the stump on the broken tooth. The surgical plan is converted into haptic guides at step D.2 (608)—either purely virtual using patient registration information, or a mechanical scaffold that affixes into the patients mouth. In this embodiment, the tracking information from the haptic drill in step C (610) is used to modify the 3D patient models created in step D.1 (606). Again, as in FIG. 5, the coterminous double arrow between step C (610) and step E (612) of FIG. 6 indicates the convergence of the final Rapid manufactured prosthetic with the process of performing the actual patient modification. Finally, this embodiment adds extra steps at step F (614), step G (616), and step H (618) to better accommodate the decision making process of the Dentist.

In the method of FIG. 6, a patient presents with a broken tooth and requires a crown at step A (502). In step B (504), the dentist takes an impression and a 3D scan of the impression is made. At step D.1 (606), a 3D model of the prosthetic is created in Design Software (114). The 3D model provides an outer shell of the tooth, a cement gap, and a desired new 3D patient situation/surface (stump). At step D.2 (608), haptic guides are calculated for the new desired 3D patient situation/surface. At step C (610), the dentist performs patient modifications with haptic guidance, using the haptic guides computed at step D.2 (608). The 3D model in step D.1 is updated using data acquired during surgery (the procedure), and additional haptic guides (step D.2, 608) are computed accordingly.

In step E (612), inputs from step C (610) are used to directly drive a rapid manufacturing (prototyping) process for the prosthetic tooth/crown. Inputs from step C (610) can also be used to recalculate the haptic guides in step D.2 (608). Design constraints from the software guide the dentist as he/she modifies the patient situation. In step F (614), it is determined whether the new manufactured tooth fits the patient. This determination may be made physically, or may be made by use of kinematic simulation described elsewhere herein. If the tooth fits, the method proceeds to step I (620), where the produced crown fits and is permanently finished. If the tooth does not fit, it is determined at step G (616) whether manual modification of the new tooth is possible, e.g., to make a fine adjustment. If this is not possible, the process returns to step C (610) for modification of the patient modification with haptic guidance. If manual fine adjustment is possible, this is performed at step H (618), and the fitting crown is finished permanently (620).

### Equivalents

While the invention has been particularly shown and described with reference to specific preferred embodiments, it should be understood by those skilled in the art that various changes in form and detail may be made therein without departing from the spirit and scope of the invention as defined by the appended claims. Insofar as this is a provisional application, what is considered applicants' invention is not necessarily limited to embodiments that fall within the claims below.

What is claimed is:

1. A method for manufacture of a prosthesis, the method comprising the steps of:
(a) creating an initial 3D model of a patient situation;
(b) creating a preliminary 3D model of a prosthesis at least using the initial 3D model of the patient situation;
(c) manufacturing a preliminary prosthesis at least using the preliminary 3D model of the prosthesis;
(d) creating and/or updating a haptic guide at least using one or more of the following:
(i) the initial 3D model of the patient situation;
(ii) an updated 3D model of the patient situation;
(iii) the preliminary 3D model of the prosthesis; and
(iv) an updated 3D model of the prosthesis.
(e) modifying the patient situation at least using an instrument comprising a haptic interface device implementing the haptic guide and updating the 3D model of the patient situation; and
(f) modifying the prosthesis with a machine substantially coterminously with step (e) and, optionally, updating the 3D model of the prosthesis.

2. The method of claim 1, wherein steps (e) and (f) are repeated until a prosthesis with proper fit is converged upon.

3. The method of claim 1 or 2, wherein the prosthesis comprises at least one member selected from the group consisting of:
(i) an artificial limb;
(ii) an internal prosthetic;
(iii) a dental prosthetic; and
(iv) a cranial/maxillo facial prosthetic.

4. The method of claim 1, wherein the haptic guide serves to restrict or otherwise guide the movement of the instrument during the modification of the patient situation.

5. A system for manufacture of a prosthesis, the system comprising:
an instrument for modifying a patient situation, in communication with or operating as part of a haptic interface device, wherein the haptic interface device is configured to provide force feedback to a user and receive input from the user;
a display configured to provide graphical feedback to the user;
a rapid prototyping (RP) device or milling machine for fabrication and/or modification of a prosthesis;
a computer with a processor and instructions configured to:
(a) create an initial 3D model of a patient situation;
(b) create a preliminary 3D model of the prosthesis at least using the initial 3D model of the patient situation;
(c) provide data for use by the rapid prototyping (RP) device or milling machine to fabricate a preliminary prosthesis at least using the preliminary 3D model of the prosthesis; and
(d) create and/or update the haptic guide at least using one or more of the following:
(i) the initial 3D model of the patient situation;
(ii) an updated 3D model of the patient situation;
(iii) the preliminary 3D model of the prosthesis; and
(iv) an updated 3D model of the prosthesis.

6. The system of claim 5, configured to perform the method of claim 1.

7. A method for manufacture of a dental crown, the method comprising the steps of:
(a) scanning a patient situation to create an initial 3D model thereof;
(b) creating an initial 3D model of a crown using said initial 3D model of the patient situation and manufacturing a preliminary crown using the initial 3D model of the crown;
(c) modifying the patient situation for fitting of the crown and updating the 3D model of the patient situation in accordance thereto; and
(d) modifying, substantially coterminously with step (c), the preliminary crown with a machine using at least the updated 3D model of the patient situation.

8. The method of claim 7, wherein steps (c) and (d) are repeated until a crown with proper fit is converged upon.

9. The method of claim 7, further comprising at least one of creating or updating a haptic guide using one or more of the following:
(i) the initial 3D model of the patient situation;
(ii) the updated 3D model of the patient situation;
(iii) the preliminary 3D model of the crown; and
(iv) the updated 3D model of the crown,
wherein step (c) comprises modifying the patient situation using the created or updated haptic guide.

10. The method of claim 9, wherein the haptic guide serves to restrict or otherwise guide the movement of the instrument during the modification of the patient situation.

11. The method of claim 7, further comprising manually modifying the crown for fine adjustment.

12. A method for manufacture of a prosthesis, the method comprising the steps of:
(a) creating an initial 3D model of a patient situation;
(b) creating a preliminary 3D model of a prosthesis at least using the initial 3D model of the patient situation;
(c) manufacturing a preliminary prosthesis at least using the preliminary 3D model of the prosthesis;
(d) creating and/or updating a graphic guide at least using one or more of the following:
(i) the initial 3D model of the patient situation;
(ii) an updated 3D model of the patient situation;
(iii) the preliminary 3D model of the prosthesis; and
(iv) an updated 3D model of the prosthesis.
(e) modifying the patient situation at least using an instrument comprising a graphic interface device implementing the graphic guide and updating the 3D model of the patient situation; and
(f) modifying the prosthesis with a machine substantially coterminously with step (e) and, optionally, updating the 3D model of the prosthesis.

13. The method of claim 12, wherein steps (e) and (f) are repeated until a prosthesis with proper fit is converged upon.
